(19) United States
(12) Patent Application Publication
(10) Pub. No.: US 2006/0011266 A1
(43) Pub. Date: Jan. 19, 2006

(54) Variable dimension engineered timber system

(76) Inventor: Michael G. Holzhey, Kelowna (CA)

Correspondence Address: Clifford W. Vermette, Vermette & Co.;Suite 230, Box 40, Granville Square, 200 Granville Street, Vancouver, V6C 1S4, CA

(21) Appl. No.: 10/889,039

(22) Filed: Jul. 13, 2004

(51) Int. Cl. B27F 7/00; B27D 1/00; B27F 1/00; B27G 11/00

(52) U.S. Cl. 144/347; 144/346; 144/344

(57) ABSTRACT

A method for fabricating a post, beam or header from elongated lumber pieces, which includes providing a plank made of elongated, edge-glued lumber pieces, cutting the plank into elongated boards of predetermined dimensions calculated to minimize cutting and trimming waste. After preparing the elongated boards for gluing each of the gluing surfaces is glued and the boards assembled into a post, beam or header. Finally, the gluing surfaces are compressed using a conventional one-dimensional press. By cutting the edge-glued planks to dimensions that allow for minimum waste in preparing the boards for gluing, the cost of fabricating beams can be minimized. By using a conventional one-dimensional press, complexity and capital costs are minimized, overall manufacturing costs are reduced, and more sophisticated glue-up patterns are possible.

### FIELD

The present invention relates to a method and apparatus for making timber systems, posts, beams or headers of variable dimensions with a minimum of cutting waste and utilizing conventional standard wood processing equipment.

### BACKGROUND

Composite posts, beams and headers are posts, beams and headers made up of elongated component pieces of lumber either specially milled to have a desired cross-sectional shape or having a rectangular square edge shape. Pieces with a square edge shape are generally selected from standard lumber such as 2×4s, 2×6s, 2×8° s., etc. If posts, beams or headers having dimensions between those possible with standard lumber are required, using such lumber can result in a large amount of waste and make the process commercially unacceptable.

If the elongated wood pieces to make a post, beam or header are available, it is then necessary to glue the pieces of lumber together to form a post, beam or header usually of square or rectangular cross section. Placing one wood piece over another constitutes a lamination process, which results in a maximum of wood fiber in a given cross-sectional area and hence a maximum cost per unit area of post, beam or header cross-section. Making a box-like structure with spaced apart sides, top and bottom results in a square or rectangular hole in the center and is a less costly structure but more difficult to fabricate than a laminated post, beam or header. Such structures require a press to compress the glue joints while they are setting and a strong guide to prevent the pieces from moving sideways during compression. Other prior art such as U.S. Pat. No. 5,870,876 issued to Deiter and U.S. Pat. No. 6,519,912 issued to Eckmann et al. require a sophisticated and costly two-dimensional press exerting pressure vertically as well as horizontally.

Using conventional large dimensional lumber for such hollow core construction creates a problem in that such lumber is dimensionally less stable and tends to warp and split easily, thereby reducing the structural integrity of the fabricated post, beam or header.

It is an object of the present invention to provide a method of minimizing lumber cutting waste and maximizing lumber recovery in making cost effective composite hollow core posts, beams or headers of any dimension, which are dimensionally stable, don't warp or split and are structurally sound. It is a further object of the invention to provide a method which can form the posts, beams or headers with a single conventional one-dimensional press.

### SUMMARY OF THE INVENTION

According to the invention there is provided a method for fabricating posts, beams, headers, and boards from elongated lumber pieces. The method includes providing a plank made of elongated, edge-glued lumber pieces and cutting the plank into elongated boards of precise, predetermined dimensions to produce stock for subsequent fabrication. The boards that are to be stock are cut so as to minimize cutting and trimming waste in subsequent operations.

Preferably, the method includes preparing the elongated boards for gluing, applying glue to each of the gluing surfaces and assembling the boards into a post, beam or header and compressing the gluing surfaces using a one-dimensional press.

The providing step may include planing the elongated lumber pieces followed by edge gluing and trimming.

The preparing step may include notching each board so as to mate with a notch on an adjacent board when the edges of the each board and the adjacent board are in a predetermined orientation.

The providing step may alternately include finger-jointing prior to planing and edge gluing of the elongated lumber pieces.

Preferably, the compressing step is applied perpendicularly to each of the gluing surfaces.

The providing step may, alternately, include finger-jointing the elongated lumber pieces, profiling edges of the elongated lumber pieces and edge gluing the profiled elongated lumber pieces.

The notches are, preferably, V-shaped.

By utilizing edge glued lumber, lumber widths of large dimensions can be achieved. Compared to solid large dimensional lumber, such edge glued lumber is much more consistent and dimensionally stable and less likely to warp and split. By cutting this material to precise widths selected to allow for planing, trimming and notching, waste fibre is minimized as is the cost of the post, beam or header. Lateral movement of the lumber pieces during gluing is avoided by providing notches and notch projections, which fit into the notches with the notch projections being parallel to the direction of force applied by the press.

The gluing process allows the operation of a conventional one-dimensional press which is proven technology requiring less capital and a lower level of complexity, thereby reducing the overall manufacturing cost of the products. At the same time it permits the fabrication of sophisticated glue-up patterns all in one gluing step including compression and tension members such as high rated machine stress rated (MSR) lumber or laminated veneer lumber (LVL) which can be added for higher strength.

There are numerous benefits which can be achieved by this invention some of which are as follows:
1. Ability to utilize low cost raw material
   Trim blocks, which can be bought at very low cost, are sorted and processed into square edge and waney sorts in order to maximize lumber recovery. This fiber sort is the lowest cost material as saw millers typically process this lumber into chips for paper production.
   Low grade lumber, which has been down-graded because of wane, an attribute not desired in traditional lumber, may be used. This lumber can be processed through a chop line to sort out the square edge and waney blocks in order to maximize fiber recovery.
   Pre-graded short block lumber can go directly into the process.
2. Ability to achieve highest recovery from purchased lumber
   Lower strength lumber can go into products such as glulam (or fascia) where a higher volume of lumber is utilized allowing the product to still meet the customer strength expectations.
   Higher strength lumber can go into the Variable Dimension Engineered timber where less lumber is utilized, effectively reducing the cost of the product.
   Square edge lumber can either be sold into traditional markets or it can be edge glued using traditional means and used in Variable Dimension Engineered timber products.
   Waney lumber can be edge glued using the technology described in my co-pending patent application Ser. Nos. ______. ______ and ______, thereby providing the highest recovery from purchased lumber.
3. Ability to construct a product with the least amount of solid lumber necessary to meet required strength requirements
   Overall a 10 to 45% fiber utilization benefit can be expected with the present invention depending on the size of post, beam or header being manufactured. This is significant given the fact that fiber is the most important cost factor.
   A benefit of a product made in accordance with this invention is that it is lighter to work with, allowing it to be easily handled on the job site without the use of cranes and other lifting equipment.
4. Ability to manufacture with high flexibility and at high production rates in order to keep costs down.
   There is no need to re-edge much of the waney blocks because they can be processed directly into the finger jointing and edge gluing process.
   The same finger jointer and edge glue lines can be used to process both the waney edge and square edge lumber keeping capital costs lower and improving operating efficiencies.
   Because a conventional one-dimensional press can be utilized, capital costs and complexity of the press line is lower. This process may also require less press equipment compared to the double-sided press option.
   The conventional press permits the addition of stabilizing members in the middle of larger products or additional tension and compression members in order to ensure performance and quality at reasonable cost.
   The volume of adhesive consumed is lower than with other engineered wood products as there are less glue lines in the products. Given the high cost of adhesives, this helps to keep costs low.
   The use of edge gluing keeps inventories to a minimum, as there is no concern with the size of the inbound lumber for any specific order. This will allow faster response to customer needs and a reduction of inventories, work in progress and costs.
5. Ability to manufacture a product of high quality and performance which the market demands
   This invention results in an engineered product which will not warp, twist, crack, check or shrink, even in larger dimensions.
   The tighter grading specifications for smaller dimensional blocks compared to that for solid lumber in larger dimensions results in a higher overall grade of finished product.
   This invention produces a product that will not swell when exposed to rain and moisture as is common with some other engineered wood products.
   The present product is a lower cost alternative compared to traditional engineered wood products.
   The present product can be available in long lengths to allow customers to chop it for builder specific requirements.
   A product is achieved by this invention which meets precise traditional finished dimensions. Such dimensions are exemplified by the following:
      typically widths of 3.5 and 5.5 inches, and
      depths of 5.5, 7.25, 9.25, 11.25, 11.875, 14, and 16 inches.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a cross-sectional view of a post made up of four different elongated pieces of lumber, two of which are different from the other two;

FIG. 2 is cross-sectional view of a portion of two beams/headers showing different shaped interlocking notches;

FIG. 3 is a cross-sectional view of a portion of two beams/headers showing a double V-shaped notch and a square-shaped notch;

FIG. 4 is a rectangular beam/header having a center stabilizer;

FIG. 5 is a large dimension square post having a center stabilizer;

FIG. 6 is a beam/header configuration with non edge-glued Lumber or LVL as compression or tension members;

FIG. 7 is a beam/header having additional compression and tension members;

FIG. 8 is a cross-sectional view of a laminated beam/header made by a conventional glue laminating process—the difference to standard glulam, however, is that this beam uses edge glued material and can be of non-standard with;

FIG. 9 is a cross-sectional view of a three-sided beam (corbel) which encloses a 2×4 rafter; and

FIG. 10 is a cross sectional view of two elongated lumber pieces glued together in the form of a corner resulting from a large square post cut into four pieces.

### DETAILED DESCRIPTION WITH REFERENCE TO THE DRAWINGS

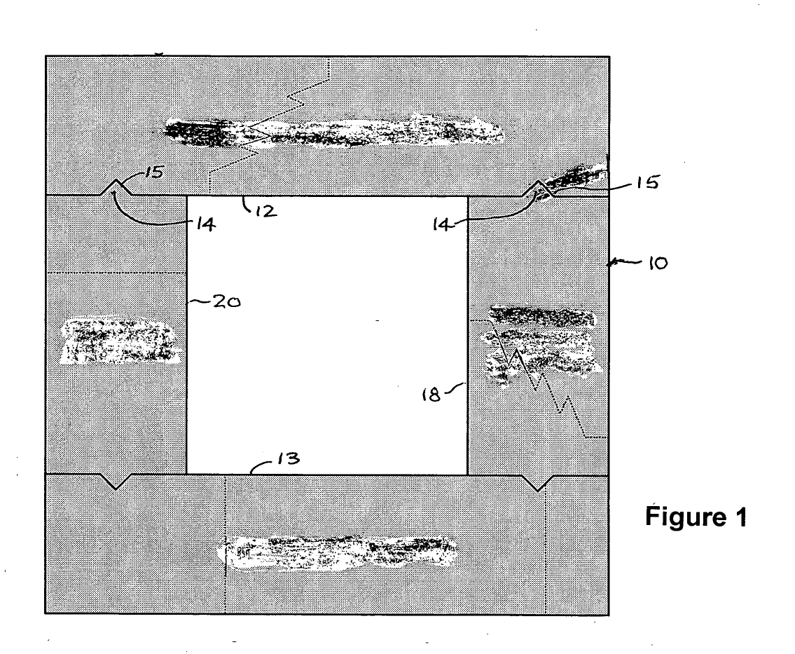

Referring to FIG. 1, a post 10 of square cross-section is formed of two lateral elongated lumber pieces 12 and 13 and two vertical elongated lumber pieces 18 and 20. In this embodiment, pieces 12 and 18 are formed using interlocking edged glued boards while pieces 13 and 20 have employed a square edge glued board. V-shaped notches 15 are milled into pieces 12 and 13 and corresponding V-shaped protrusions 14 on pieces 18 and 20. The notches 15 and protrusions 14 positioned so that upon alignment as shown, the protrusions 14 fit into the notches 15 and hold the pieces 12, 13, 18, and 20 in position. The lumber pieces 12, 13, 18, and 20 can be cut to the exact required dimensions thereby minimizing trim and planer waste. Alignment of the interlocking notches 15 and projections 14 along a single direction allows the use of a single press to glue the beam pieces together.

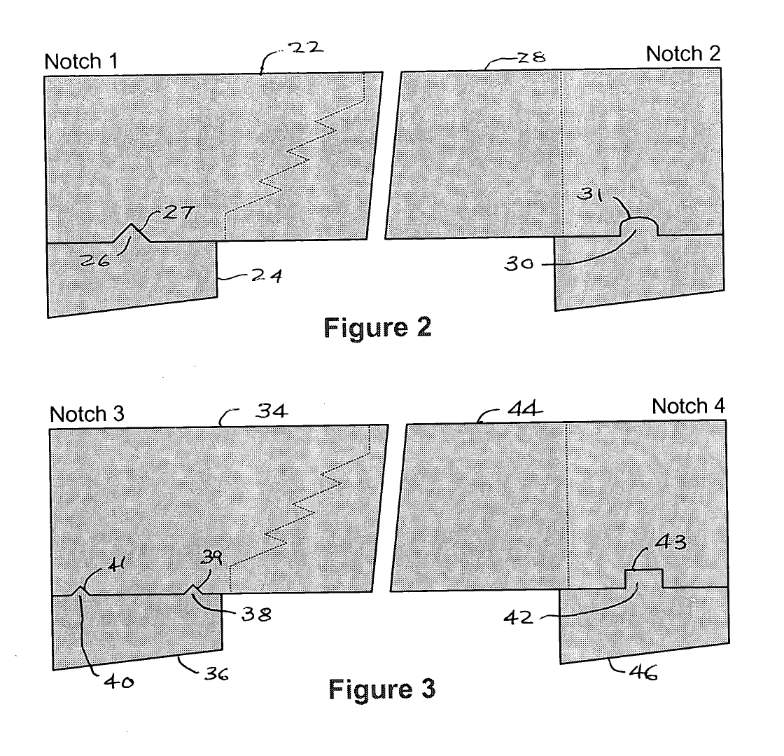

Referring to FIGS. 2 and 3 there are shown various interlocking configurations. In FIG. 2 there is shown a single V-shaped notch 27 formed in piece 22 and a projection 26 formed in piece 24. There is also shown a projection 30 in piece 32 having parallel sides with a rounded top and a corresponding notch 31 in piece 28. In FIG. 3 there is shown a pair of V-shaped projections 38 and 40 in piece 36 and V-shaped notches 39 and 41 in piece 34 forming interlocking elements. Also shown in FIG. 3 is a projection 42 with a rectangular cross-section in piece 46 and a corresponding notch 43 with rectangular cross-section forming an interlocking configuration. FIGS. 2 and 3 are embodiments of typical interlocking configurations; other configurations are also possible.

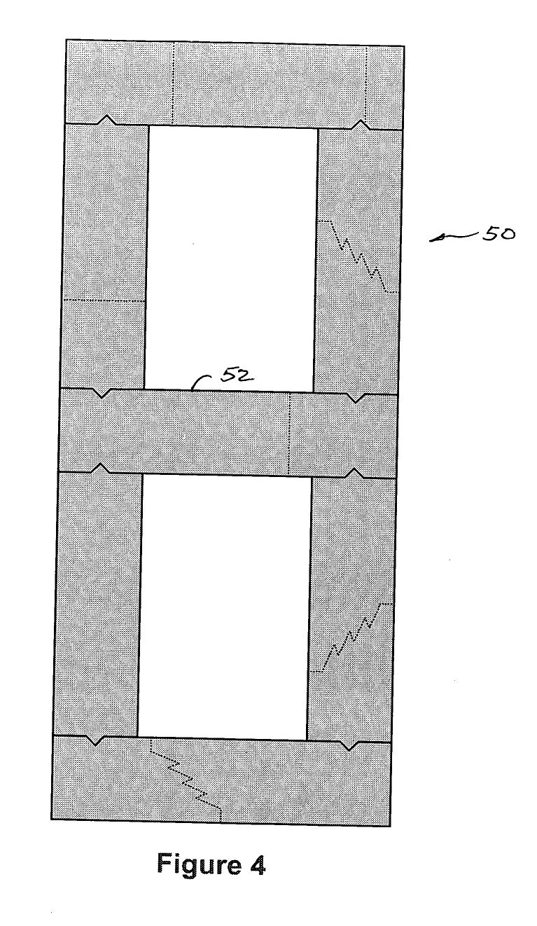

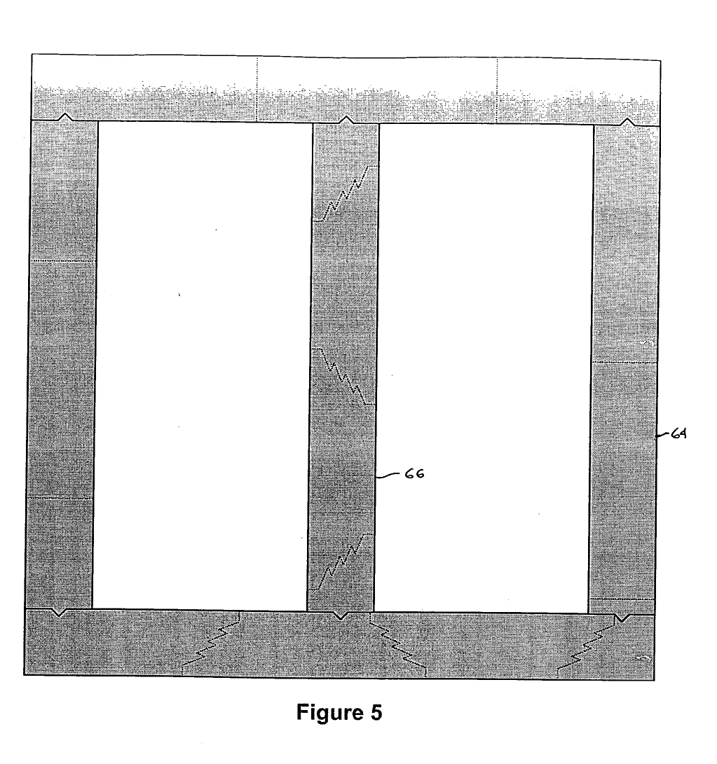

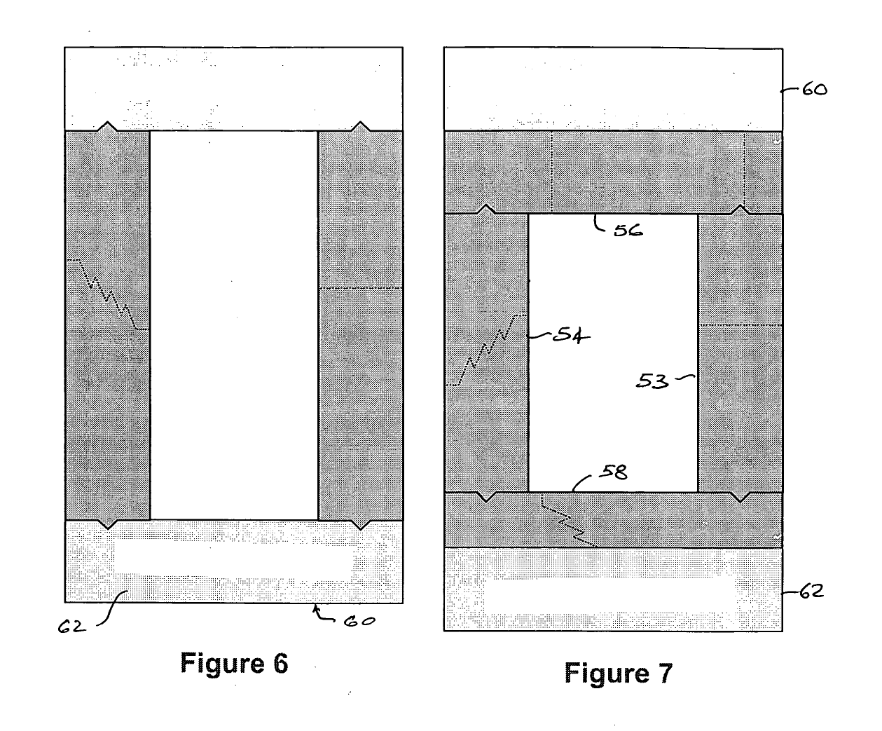

Referring to FIG. 4 there is shown a compound configuration of elongated lumber pieces forming a rectangular beam/header 50 with a center stabilizer piece 52 for added strength and stability. FIG. 5 shows an alternative post 64 of square cross-section with a center stabilizer 66 extending from the interior of a top of the beam 64 to the interior of a bottom of the beam 64. FIG. 6 is a beam/header configuration 60 with non edge-glued Lumber or LVL 62 as compression or tension members and FIG. 7 is a rectangular beam/header with sides 56 and 58 and 53 and 54 has additional compression member 60 and tension member 62 laminated on top and bottom, respectively.

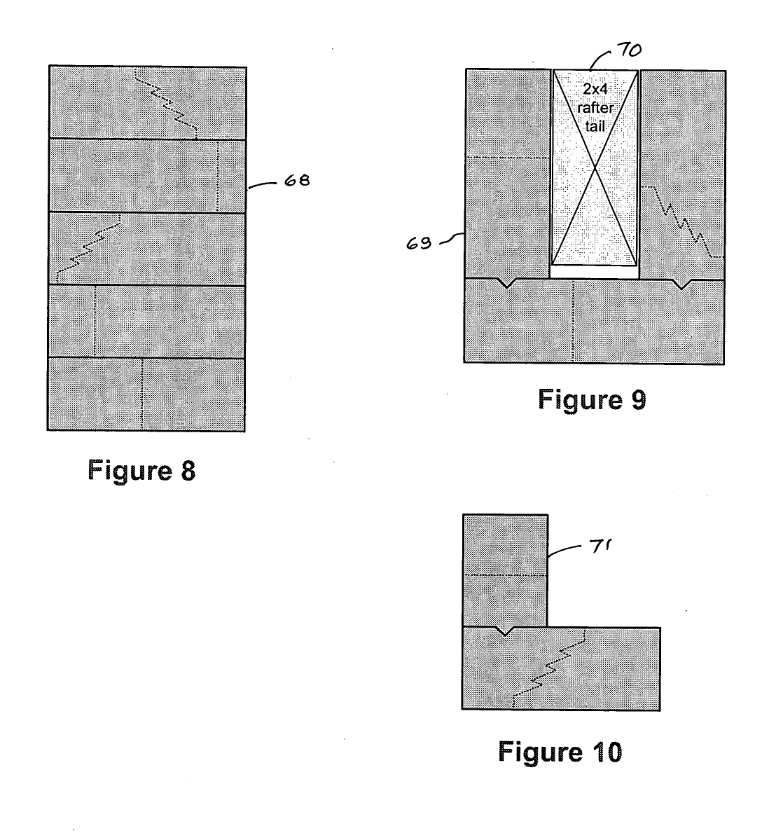

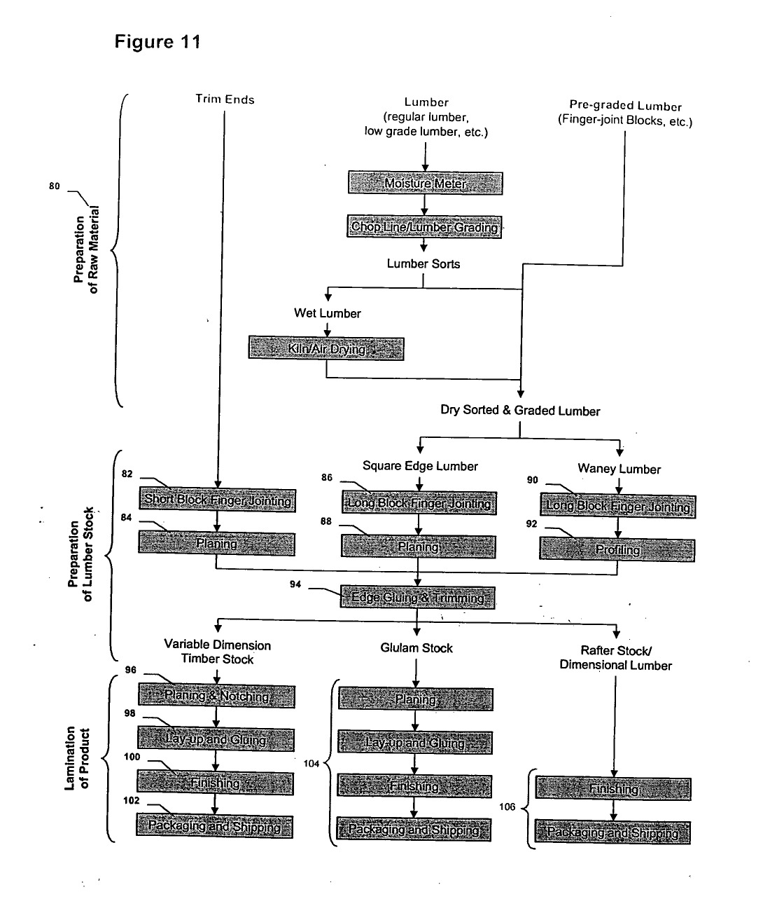

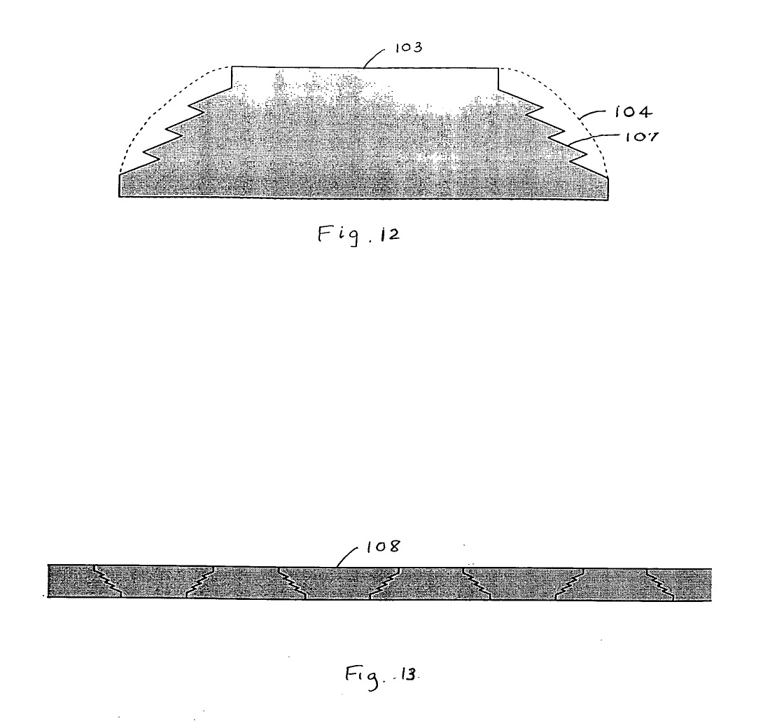

Alternative structures can be built such as the conventional glulam beam/header 68 in FIG. 8, the U-shaped beam 69 (corbel) which engages a rafter tail 70 seen in FIG. 9 and the L-shaped corner structure 71 shown in FIG. 10.

As seen in FIG. 11, the process of fabricating the various composite posts, beams or headers consists of using conventional lumber, measuring its moisture content and grading it in the chop line. Wet lumber is kiln/air dried when required. In addition or alternatively, pre-graded lumber, such as finger-joint blocks, or trim ends can be used.

The standard system is able to handle both square-edged lumber and waney lumber. Waney lumber is lumber cut from near the outside of the log with one or both corners rounded off and irregular.

At steps 86 and 90, the lumber pieces are finger jointed to other such pieces to achieve the requisite length. Short trim ends are finger jointed at step 82 in the short block finger jointing line. If the lumber is square edged it is planed at step 88 and then edge-glued and trimmed at step 94. Step 94 can be omitted if the input lumber has already the desired dimension.

For waney lumber, a special profiling at the corners is milled at step 92 in order to make the lumber useable to make planks. After profiling at step 92, the lumber is edge-glued and trimmed at step 94. FIGS. 12 and 13 show, as an example, a waney 2×6 having sloped edges 104 as shown in dotted outline being profiled at step 92 to form finger-like faces 107. By reversing alternate profiled 2×6s 103, applying glue to the finger-like faces and pressing them together, at step 94 one gets a plank 108 with lateral dimensions as wide as desired.

The resultant structure after step 94 is a plank made of edge-glued profiled or square-edged lumber. With edge-glued lumber it is possible to cut the plank to the exact width required for a given post, beam or header, leaving as little waste as possible; the only exception being if the input lumber has already the desired dimension, then trimming in step 94 would be bypassed.

Depending on market situation and customer demand there are a number of possible processing options for the boards made up of edge-glued profiled or square-edged lumber or the finger jointed input lumber:
a) Variable Dimension Engineered Timber;
b) Laminated Beams of variable dimensions in cross-section in steps 104; or
c) Rafter or conventional lumber in steps 106.

For the Variable Dimension Engineered timber, the boards are planed and notched at step 96. At step 98, the lumber is then laid-up and glued together to form a post, beam or header using a conventional one-dimensional press. With the notches as shown in FIG. 1 pointing along a direction parallel to a common axis, the fitted lumber pieces become self-aligning, and when compressed do not tend to drift laterally as could otherwise be the case. When the glue is dried, the post, beam or header is then finished at step 100 and packaged and shipped at step 102.

The steps 104 describe fabrication of a conventional laminated beam, but one which can be of any desired dimensions.

It is obvious that various interlocking, profiled shapes are possible. It is also obvious that one can bypass the finger jointing step if lumber of sufficient length and quality is available. It is also obvious that the final product in the process of FIG. 11 up to step 94 could be conventional boards or lumber of any desired width cut from edge-glued planks 108.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

I claim:

1. A method for fabricating posts, beams, and headers from elongated lumber pieces, comprising:
(a) providing a plank made of elongated, edge-glued lumber pieces;
(b) cutting the plank into elongated boards of precise, predetermined dimensions to produce stock for subsequent fabrication of posts, beams and headers, wherein the boards that are to be stock are cut so as to minimize waste in subsequent fabrication steps; and
(c) preparing the stock for incorporation into a post, beam or header;

2. The method of claim 1, including:
(a) preparing the elongated boards for gluing;
(b) applying glue to each of said gluing surfaces and assembling said boards into a post, beam or header; and
(c) compressing said gluing surfaces in one dimension.

3. The method of claim 1, wherein said preparing step includes planing the boards.

4. The method of claim 3, wherein said preparing step further includes notching each board so as to mate with a notch on an adjacent board when the edges of said each board and said adjacent board are in a predetermined orientation.

5. The method according to claim 1, wherein said providing step includes finger-jointing and planning said elongated lumber pieces to form a plank and trimming said plank.

6. The method according to claim 2, wherein said compressing step is performed by a conventional one-dimensional press.

7. The method according to claim 2, wherein compressing step is applied perpendicular to each of said gluing surfaces.

8. The method according to claim 1, wherein said providing step includes finger-jointing said elongated lumber pieces, profiling edges of said elongated lumber pieces, edge gluing said profiled elongated lumber pieces and trimming said edge-glued lumber pieces.

9. The method according to claim 1, wherein said notches are V-shaped.

10. The method according to claim 2, wherein said compressing step is performed by a one dimensional press.

11. The method according to claim 1, wherein said providing step includes:
(a) finger-jointing trim ends;
(b) planing the finger-jointed trim ends; and
(c) edge gluing and trimming the finger-jointed trim ends.

12. The method according to claim 1, wherein said providing step includes:
(a) finger-jointing waney lumber;
(b) profiling said finger-jointed lumber; and
(c) edge gluing and trimming said profiled and finger-jointed lumber.
